(19) United States
(12) Patent Application Publication
(10) Pub. No.: US 2023/0274157 A1
(43) Pub. Date: Aug. 31, 2023

(54) INGESTION OF DATA FOR MACHINE LEARNING DISTRIBUTED TRAINING

(71) Applicant: Intel Corporation, Santa Clara, CA (US)

(72) Inventors: Vikram Saletore, Hillsboro, OR (US); Yaser Afshar, Santa Clara, CA (US)

(73) Assignee: Intel Corporation, Santa Clara, CA (US)

(21) Appl. No.: 18/312,276

(22) Filed: May 4, 2023

(51) Int. Cl. G06N 3/098

(52) U.S. Cl. CPC G06N 3/098

(57) ABSTRACT

Systems and methods include technology that identifies a first shard of shards of training data, where the training data is stored on a storage array, where the training data is divided into shards. The technology stores the first shard onto a first data storage of a first compute node, and copies the first shard from the first data storage of the first compute node onto a second data storage of the first compute node. The technology trains a machine learning model on the first shard stored in the second data storage during a first epoch of a training phase.

### TECHNICAL FIELD

Examples generally relate to machine learning (e.g., artificial intelligence (AI), neural network, deep learning, etc.) training. In particular, examples include a training data ingestion scheme that operates at memory speeds to train the machine learning model.

### BACKGROUND

Deep learning (DL) technology and other AI related technology drive remarkable advances in fields such as object detection, image classification, speech recognition, natural language processing, etc. Deep learning leverages deep artificial neural networks (NNs), including convolutional neural networks (CNNs), to automate the discovery of relevant features in input data. Neural networks may produce useful outputs if the neurons have been assigned a suitable set of weights and biases. For example, the neural networks may be trained with training data during a training process to optimize the weights and biases.

### BRIEF DESCRIPTION OF THE DRAWINGS

The various advantages of the embodiments will become apparent to one skilled in the art by reading the following specification and appended claims, and by referencing the following drawings, in which:

FIGS. 1A, 1B and 1C are an example of a data-enhanced machine learning process according to an embodiment;

FIG. 2 is a flowchart of an example of a method of executing a training phase according to an embodiment;

FIGS. 3A, 3B and 3C are an example of a data shuffling process according to an embodiment;

FIG. 4 is an example of a block diagram of a processing diagram according to an embodiment;

FIG. 5 is a diagram of an example of a training enhanced computing system according to an embodiment;

FIG. 6 is an illustration of an example of a semiconductor apparatus according to an embodiment;

FIG. 7 is a block diagram of an example of a processor according to an embodiment; and

FIG. 8 is a block diagram of an example of a multi-processor based computing system according to an embodiment.

### DESCRIPTION OF EMBODIMENTS

During the training of neural networks, identifying optimal weights and biases may be a computationally expensive process since the parameter space may be enormous. For example, training a neural network may include finding a global minimum (or a close approximation) of a function with millions of parameters. One optimization algorithm commonly used for training deep neural networks is stochastic gradient descent (SGD). SGD is based on the notion that all of the operations in a neural network are differentiable with respect to their weights and biases.

During training, SGD fetches and feeds random mini-batches of pre-labeled training data (e.g., images) to a network, quantifying how accurately the network may classify the input via a differentiable loss or error function E. Such a process is referred to as forward propagation. The network then computes the gradient ∂/∂w(E) of the loss function with respect to the current weights w. On the basis of the gradients, weights are updated according to the equation below, where w′ are the updated weights, w is the weight prior to the adjustment process and θ is a tunable parameter called the learning rate as indicated below in Equation 1:

$${w}^{′} = w - θ \frac{\partial }{\partial w} ( E ) \qquad Equation 1$$

Since each respective layer of neural network layer is a differentiable function of the layer that precedes the respective layer, the gradients are computed layer-by-layer via the chain rule of differential calculus, moving from output to input, in a process called backward propagation.

Finally, the weights in the network are updated according to the computed gradients, and the process repeats with a fresh random mini-batch of data until the network (e.g., machine learning model) has reached a satisfactory degree of accuracy relative to the ground truth.

Training is an enormously expensive computational process. Training may require millions of steps of the SGD process, and the training time on a realistic problem may execute over days or even weeks on large datasets (e.g., terabytes) on a single system. For this reason, a significant level of effort has been expended on optimizing neural network training for parallel architectures such as (e.g., graphics processing unit tiles, GPU Tiles, XPUs, field programmable gate arrays, and application specific integrated circuits). In order to meet growing demands, deep learning processes often leverage large compute clusters to bring training time down to an acceptable range.

An extension of SGD, called synchronous SGD, allows training work to be divided across multiple nodes. An iteration of synchronous SGD across N nodes proceeds by executing multiple passes of SGD as described above in parallel, one on each node, with each node processing a different and random mini-batch. The nodes then communicate the gradient computed against local mini-batches to each other in an “all-reduce” fashion. Each node then takes the sum of these gradients, and applies the sum to a locally held copy of the weights and biases. Doing so ensures that each node operates with the same weights and biases throughout the process. The algorithm then continues with a new set of N mini-batches, and repeats until convergence is reached. An epoch may be a model training that is executed over one pass over the full dataset. AI model training to convergence may require a very large number (e.g., hundreds to thousands of epochs depending on the dataset size) of mini-batch training steps per epoch and hundreds of epochs.

Datasets (e.g., training data) may be significant in size to increase the accuracy of the machine learning model. A single copy of a large sized dataset may be stored on a shared file system (SFS) that is accessible to all the compute nodes in a cluster via an interconnect. In existing examples, the compute nodes fetch random mini-batches in parallel from the SFS at each step of the SGD algorithm. Doing so may result in several performance considerations, such as the performance of SFS. For example, an SFS has performance bottlenecks when a significant number of compute nodes perform random

READs of mini-batches (e.g., random READs may have much lower Input/Output (I/O) performance compared to sequential READs) resulting in higher latency. The bandwidth to the SFS may be limited by the storage interconnect and result in an increased latency to fetch the random mini-batches. The I/Os Per Sec (IOPS) may be constrained by a speed of the compute nodes to READ the random mini-batches.

As the compute performance increases with enhanced computational hardware, the compute time for a mini-batch for AI training during forward and backward propagation reduces. If the I/O latency for fetching a mini-batch exceeds the compute time during a prefetch operation for the next training iteration, the next training iteration will be constrained (e.g., restrained) by the rate of I/O ingestion time. Doing so results in reduced performance and increased training times, and cannot leverage the lower processing times of the enhanced computational hardware. Thus, existing examples are constrained by I/O ingestion bottlenecks.

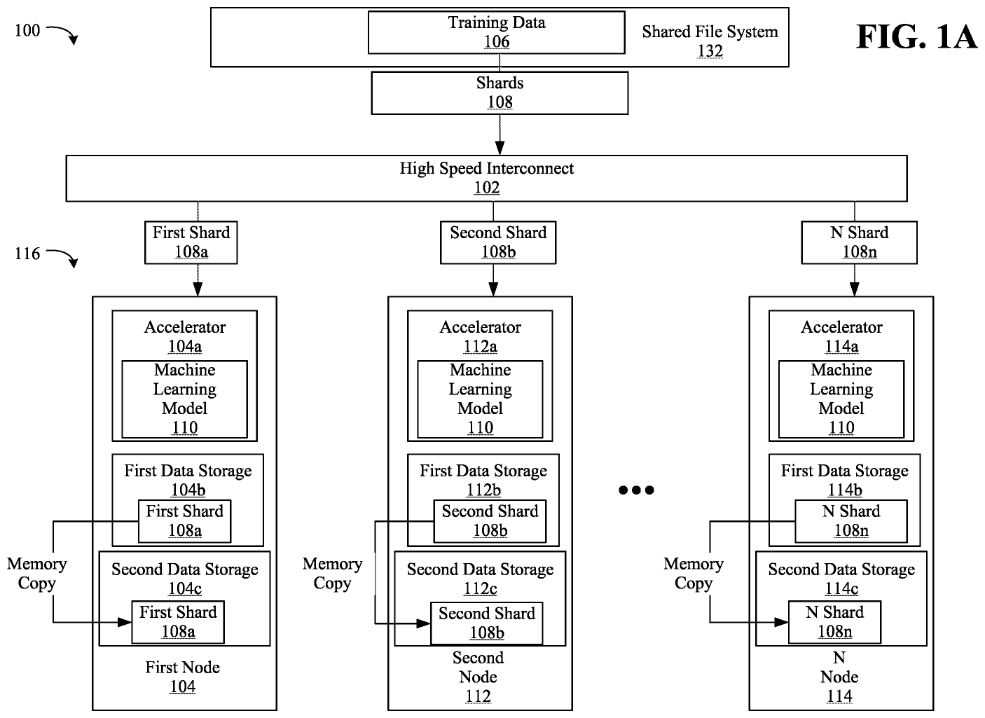

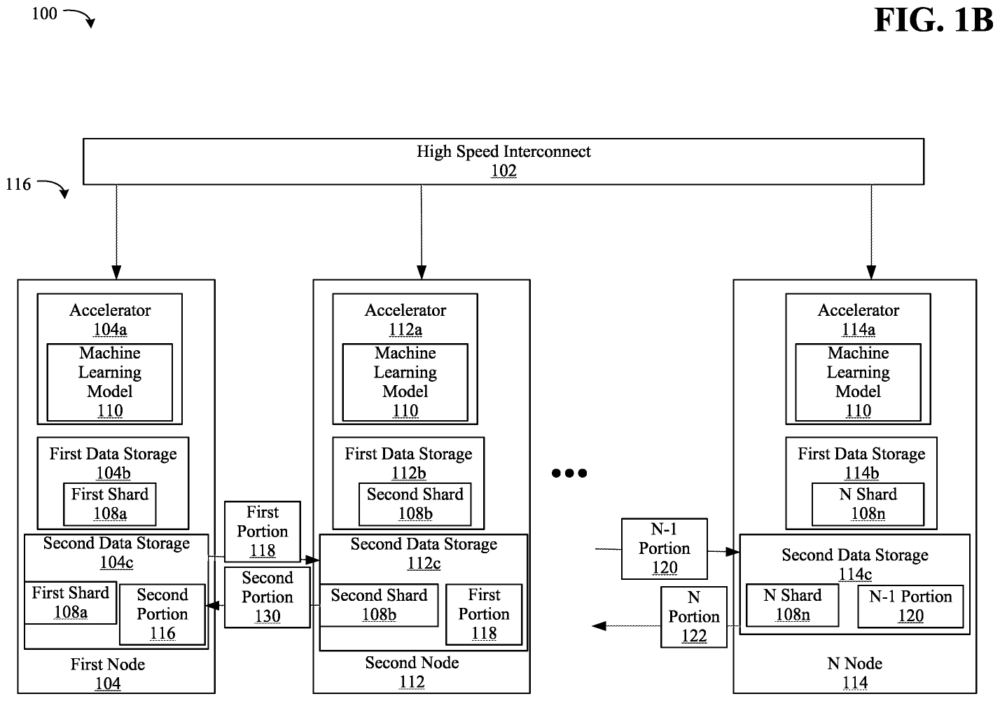

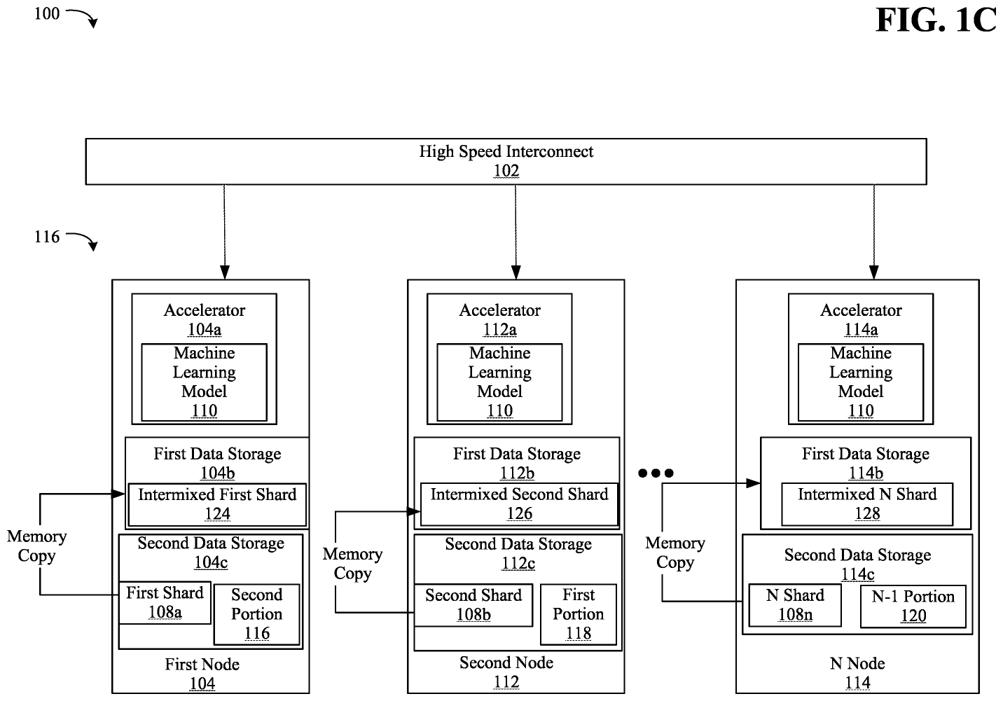

Turning now to FIGS. 1A-1C, a data-enhanced machine learning process 100 is illustrated. As will be discussed below, examples may address the I/O ingestion bottleneck by having have each node of cluster nodes 116 read a shard of training data 106 (e.g., the shards are datasets of approximately equal chunks) onto a local first memory (e.g. dynamic random-access memory (DRAM), High Bandwidth Memory, or fast data storage) only once prior to executing a training process. Examples also preserve a copy of the shard on a second memory (e.g., another DRAM, High Bandwidth Memory, and/or fast data storage) for data shuffling. Data shuffling may facilitate model convergence which is the completion of training.

At each training step, the cluster nodes 116 prefetch random mini-batches of data from respective shards stored on first memories at memory speeds. Additionally, during a training epoch, each set of two nodes in the cluster nodes 116 exchange over the cluster interconnect, a predetermined percentage (e.g., X % which may be user defined) of data of respective shards with each other to be appended to the shards in the second memory. At the end of each training epoch, each compute node copies X % exchanged data and (100−X)% of the data from the second data storage to first data storage at memory speed and shuffle in memory at memory speed. The original copy of the data shard on second data storage is not altered and saved for successive epochs. Nodes may synchronize in the usual manner and repeat the training process for the next epoch using newly shuffled data shard mini-batches from the first data storage at memory speeds.

Doing so enables the training of large AI models for large datasets at significantly faster speeds with enhanced hardware. That is, examples may mitigate and/or prevent the I/O bottleneck issues referenced above to leverage the hardware capabilities of devices.

In FIG. 1A, training data 106 is provided. The training data 106 may comprise any type of training data (e.g., images, vehicle related data, sensor data, words, queries etc.). The training data 106 may be divided into shards. Thus, shards 108 of the training data 106 may be transmitted over a high-speed interconnect 102 to the cluster nodes 116.

Each of the cluster nodes may train a machine learning model 110 (e.g., a neural network) as described above (e.g., via a synchronous SGD process). For example, a first node 104 may train the machine learning model 110 with an accelerator 104a. Similarly, the other nodes of the cluster nodes 116, including the second node 112 and the N node 114, may train the machine learning model 110 on accelerators, including accelerators 112a, 114a. The accelerators, including the accelerators 104a, 112a, 114a, may be any type of accelerator, such as graphics processing units, XPUs, VPUs, etc.

Each of the cluster nodes 116 includes two data storages (e.g., first and second memories or storages), that are each sized to hold at least one and at most two shard of the shards 108 or more. For example, the second memory may need to store two data shards if X=100% (e.g., whole data shards are exchanged). In some examples, more than two data storages may be included. The first node 104 (e.g., a first compute node) includes a first data storage 104b and a second data storage 104c, the second node 112 (e.g., a second compute node) includes first data storage 112b and second data storage 112c, and N node 114 includes first data storage 114b and second data storage 114c. The cluster nodes 116 may include any number of nodes.

The cluster nodes 116 read the shards 108 from a SFS 132 and copy the shards 108 to data storages of the cluster nodes 116. In this example, the shards 108 are provided to the cluster nodes 116 through the high-speed interconnect 102. The first node 104 receives a first shard 108a of the shards 108, the second node 112 receives a second shard 108b of the shards 108, and the N node 114 receives an N shard 108n of the shards 108.

The first node 104 stores the first shard 108a into the first data storage 104b. The first shard 108a may then be copied at memory speed from the first data storage 105b to the second data storage 104c. Thus, both the first data storage 104b and the second data storage 104c contain a copy of the first shard 108a. The machine learning model 110 may be trained in an iterative process over mini-batches of the first shard 108a stored in the first data storage 104b. For example, the first node 104 may randomly pre-fetch random mini-batches of data from the first shard 108a stored in the first data storage 104b while training on a current mini-batch of data from the first shard 108a stored in the first data storage 104b. Thus, examples store the first shard 108a of the shards 108 onto the first data storage 104b, copy the first shard 108a from the first data storage 104b onto the second data storage 104c, and train the machine learning model 110 on the first shard 108a stored in the first data storage 104b during a first epoch of a training phase.

The second node 112 stores the second shard 108b into the first data storage 112b. The second shard 108b may then be copied at memory speed to the second data storage 112c. Thus, both the first data storage 112b and the second data storage 112c contain a copy of the second shard 108b. The machine learning model 110 may be trained in an iterative process over mini-batches of the second shard 108b stored in the first data storage 112b similarly to as described above. Similarly, the N node 114 may receive the N shard 108n, store the N shard 108n into the first data storage 114b, copy the N shard 108n into the second data storage 114c and train the machine learning model 110 based on the N shard 108n stored in the first data storage 114b over multiple iterations.

In some examples, the machine learning model 110 may be trained in an iterative process over several iterations of the data of the first 108a, the second shard 108b and the N shard 108n during multiple epochs. Data may be exchanged at a time during a respective epoch to train in the following epochs. Other nodes (unillustrated) and shards may be included. An epoch may be defined as training over the full dataset once. The machine learning model 110 may be trained over many epochs (hundreds to thousands). An iteration may also be referred to as a step and is training over one mini-match by each node. If there are N-Nodes training in parallel, then the machine learning model 110 is partially trained on N-minibatches at each iteration or step. There may be a large number of iterations per epoch. For better convergence accuracy, partial data is exchanged among nodes during each epoch for training in the following epoch.

For example, and turning now to FIG. 1B, during each epoch exchange, a percentage of random data is traded between pairs of compute nodes of the cluster nodes 116. The exchange of data inserts randomness into the data-enhanced machine learning process 100 to facilitate convergence and completion of the training phase. The exchanged data is appended to data in the second data storages 104c, 112c, 114c. In some examples, the exchanged data may overwrite data in the second data storage 104c, 112c, 114c. Doing so may ensure a mixture of random data from local and remote nodes of the cluster nodes 116. Notably, the SFS 132 may be bypassed and further data retrieval from the SFS 132 may be bypassed.

In this example, a first portion 118 of the first shard 108a is transferred from the second data storage 104c to the second data storage 112c. The first portion 118 may comprise X % of the first shard 108a, where X is less than 100. The transfer may occur over the high-speed interconnect 102. Similarly, a second portion 130 of the second shard 108b is transferred from the second data storage 112c to the second data storage 104c over the high-speed interconnect 102. The second portion 130 may comprise X % of the second shard 108b, where X is less than 100. Thus, the second data storage 104c includes the first shard 108a and the second portion 130, and the second data storage 112c includes the second shard 108b and the first portion 118.

Similarly, the N node 114 may transfer an N portion 122 of the N shard 108n from the second data storage 114c to a second data storage of another node, such as an N−1 node (unillustrated). The N portion 122 may comprise X % of the N shard 108n, where X is less than 100. The transfer may occur over the high-speed interconnect 102. Similarly, an N−1 portion 120 of an N−1 shard may be transferred from the second data storage of the N−1 node (unillustrated) to the second data storage 114c over the high-speed interconnect 102. The N−1 portion 120 may comprise X % of the N−1 shard, where X is less than 100. Thus, the second data storage 114c includes the N−1 portion 120 and the N shard 108n, and the second data storage of the N−1 node would include the N−1 shard and the N portion 122 (unillustrated).

During each epoch, the set of nodes that exchange data may change. For example, if a 16 node cluster is provided, the pairs of nodes may vary with each epoch with neighbor distances being 1, 2, 4, 8. In the following example, the pairs of nodes are signified with a hyphen between the two nodes, and each node is assigned a number from 0-15.
Epoch1: (Nodeₖ-Nodeₖ₊₁): 0-1, 2-3, 4-5, 6-7, 8-9, 10-11, 12-13, 14-15
Epoch2: (Nodeₖ-Nodeₖ₊₂): 0-2, 1-3, 4-6, 5-7, 8-10, 9-11, 12-14
Epoch3: (Nodeₖ-Nodeₖ₊₄): 0-4, 1-5, 2-6, 3-7, 9-13, 10-14, 11-15
Epoch4: (Nodeₖ-Nodeₖ₊₈): 0-8, 1-9, 2-10, 3-11, 4-12, 5-13, 6-14, 7-15
Epoch5: (Node₁-Nodeₖ₊₁): 0-15, 1-2, 3-4, 5-6, 7-8, 9-10, 11-12, 13-14
   In the above example, each epoch adjusts the neighbor distance. For example, the following formula may define the pairs of nodes:

Pair=Node Number, Node Number+distance Equation 2

In each epoch, the distance may be changed. Equation 2 may be applied to the nodes until all nodes are paired. So for example, in epoch 4, the distance is 8. Thus, node number 0 is paired with node 8, node 1 is paired with node 9 and so forth. Changing the pairs of nodes that exchanges data during the epochs inserts more randomness into the training process which facilitates convergence and more accurate models.

Turning now to FIG. 1C, at the end of the first epoch, all cluster nodes 116 shuffle the transferred data and shard data. For example, the first node 104 shuffles the second portion 130 (e.g., data comprising X % of a shard) copied from the second node 112 (e.g., a neighbor node) and (100−X)% of the first shard 108a stored on the second data storage 104c, and stores the shuffled data as intermixed first shard 124 onto the first data storage 104b at memory speed. That is, the intermixed first shard 124 comprises a first amount (e.g., 80%) of the first shard 108a, and a second amount (e.g., 20%) of the second shard 108b mixed together at random. The summation of the first amount and the second amount may be equal to one complete shard. In some examples, the second portion 130 may be copied and overwrites random parts of the first shard 108a to generate the intermixed first shard 124.

Similarly, the second node 112 may mix a first amount of the second shard 108b and a second amount of the first portion 118 to generate an intermixed second shard 126 that is copied into the first data storage 112b. In some examples, the second amount of the first portion 118 may be copied and overwrites random parts of the second shard 108b to generate the intermixed second shard 126.

Similarly, the N node 114 may mix a first amount of the N shard 108n and a second amount of the N−1 portion 120 to generate an intermixed N shard 128 that is copied into the first data storage 114b. In some examples, the second amount of the N−1 portion 120 may be copied and overwrites random parts of the N shard 108n to generate the intermixed N shard 128. It is worthwhile to note that the intermixing and copying described above occurs at memory speed which is significantly faster than transferring data over the high-speed interconnect 102.

After copying and mixing noted above is completed, examples may then train the machine learning model based on the intermixed first shard 124 (which may be referred to as a third shard in some examples), the intermixed second shard 126 and the intermixed N shard 128 during a second epoch. It is worthwhile to note that the intermixed first shard 124, the intermixed second shard 126 and the intermixed N shard 128 may be considered to be different than the first shard 108a, the second shard 108b and the N shard 108n respectively. The above process may repeat for any number of epochs until convergence is reached and the training phase is over. Thereafter, the machine learning model 110 (e.g., neural network) may execute inference.

Thus, as described, the cluster nodes 116 prefetch mini-batches from the first data storages 104b, 112b, 114b at memory speeds, thus eliminating any I/O ingestion bottlenecks and accelerating overall performance. A global shuffle is achieved with pairs of compute nodes of the cluster nodes 116 by exchanging a small percentage of data over the high-speed interconnect 102 during an epoch. A local shuffle is achieved within the cluster nodes 116 at memory speeds. Distributed training proceeds with the efficiency and performance of compute nodes that comprise accelerators (XPUs, GPUs, ASICS, etc.) with large datasets that may not be bottlenecked by I/O ingestion. Examples may be offloaded to an intellectual property (IP) block with a driver offloading the compute engines and providing the efficient solution to the I/O ingestion problem.

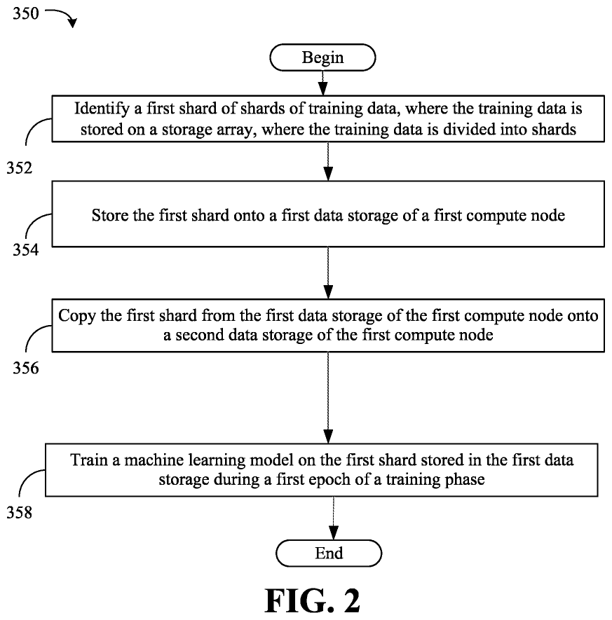

FIG. 2 shows a method 350 of executing a training phase with enhanced I/O efficiency according to embodiments herein. The method 350 may generally be implemented with the embodiments described herein, for example, the data-enhanced machine learning process 100 (FIG. 1) already discussed. More particularly, the method 350 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), general purpose microprocessor or combinational logic circuits, and sequential logic circuits or any combination thereof. The configurable or fixed-functionality logic can be implemented with complementary metal oxide semiconductor (CMOS) logic circuits, transistor-transistor logic (TTL) logic circuits, or other circuits.

For example, computer program code to carry out operations shown in the method 350 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 352 identifies a first shard of shards of training data, where the training data is stored on a storage array, where the training data is divided into shards. Illustrated processing block 354 stores the first shard onto a first data storage of a first compute node. Illustrated processing block 356 copies the first shard from the first data storage of the first compute node onto a second data storage of the first compute node. Illustrated processing block 358 trains a machine learning model on the first shard stored in the first data storage during a first epoch of a training phase.

In some examples, the method 350 receives, after the first epoch, a second portion of a second shard of the shards from a second compute node, and stores the second portion into the second data storage. In such examples, the method 350 transfers the second portion of the second shard from the second data storage to the first data storage. In such examples, the method 350 overwrites a first portion of the first shard stored in the first data storage with the second portion to generate a third shard. In some examples, the method 350 may further shuffle data of the third shard stored in the first data storage, and train the machine learning model based on the third shard stored in the first data storage during a second epoch of the training phase, where the transferring comprises transferring the second portion from the second data storage to the first data storage at memory speed.

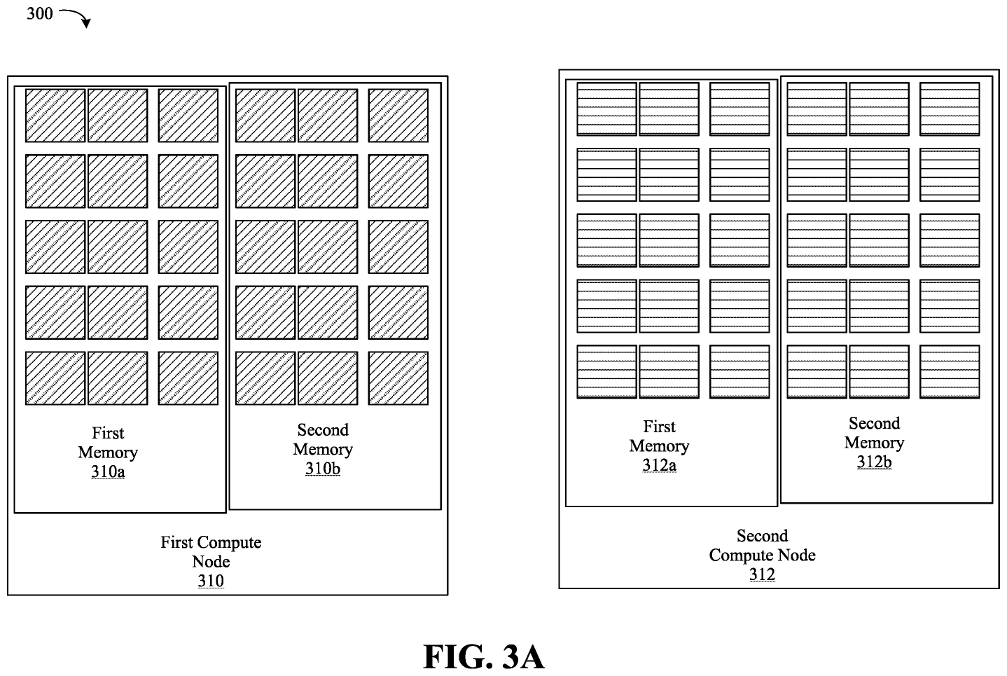

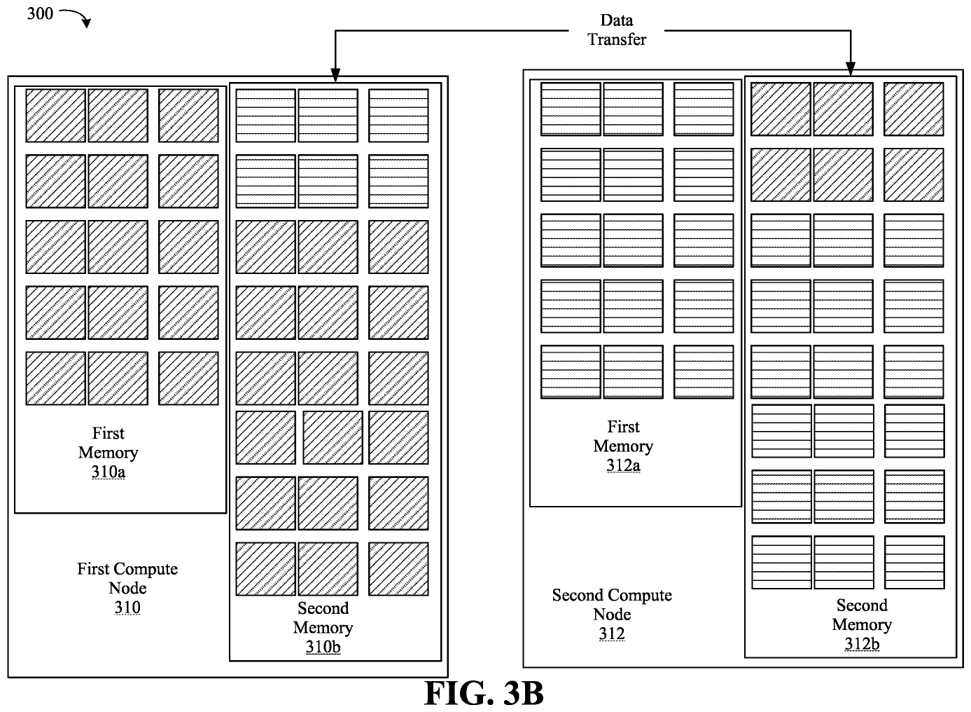

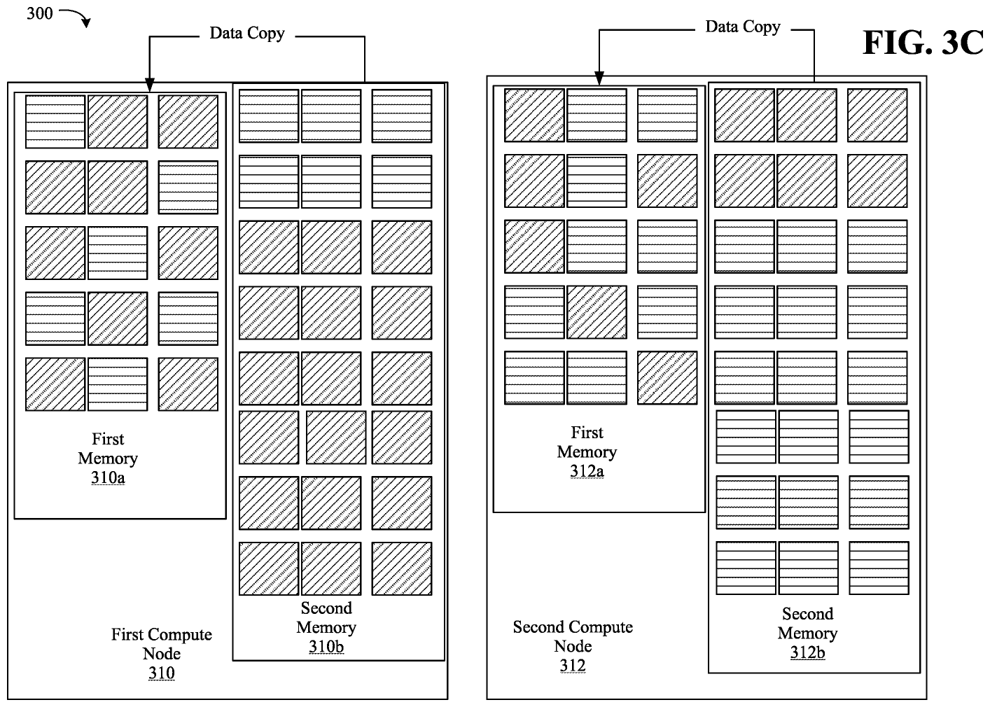

Turning now to FIGS. 3A-3C, a process 300 of copying data and shuffling data to achieve I/O efficiency is illustrated. The process 300 may generally be implemented with the embodiments described herein, for example, the data-enhanced machine learning process 100 (FIG. 1) and/or method 350 (FIG. 2) already discussed.

In FIG. 3A, a data shuffling process 300 first includes a first data shard (shown as having diagonal lines) stored in both a first memory 310a and a second memory 310b of a first compute node 310. Each data element of the first shard is shown as a separate box with diagonal lines. That is, each of the first and second memories 310a, 310b contains a copy of the first data shard.

Similarly, a second data shard (shown as having horizontal lines) is stored in both a first memory 312a and a second memory 312b of a second compute node 312. Each data element of the second shard is shown as a separate box with horizontal lines. That is, each of the first and second memory 312a, 312b contains a copy of the second data shard. The first compute node 310 and the second compute node 312 may train a machine learning model based on the first shard and the second shard respectively during a current epoch.

Turning now to FIG. 3B, the first compute node 310 and the second compute node 312 exchange data prior to the current epoch being completed. A first portion of the first shard is transferred from the second memory 310b of the first compute node 310 to the second memory 312b of the second compute node 312, and a second portion of the second shard is transferred from the second memory 312b of the second compute node 312 to the second memory 310b of the first compute node 312. Doing so may enable random data to be inserted into the training of the machine learning model on the first compute node 310 and the second compute node 312. Notably, the exchanged data is appended to the existing data in the second memories 310b, 312b.

Turning now to FIG. 3C, the data (which comprises part of the first shard and part of the second shard) of the second memory 310b is copied to the first memory 310a and shuffled to generate a third shard. The data of the first shard copied from the second memory 310b may be selected at random. Notably, only a subset of the first shard is copied to avoid exceeding a shard size in the first memory 310a. Similarly, the data (which comprises part of the first shard and part of the second shard) in the second memory 312b is copied and shuffled into the first memory 312a to generate a fourth shard in the first memory 312a. The data of the second shard copied from the second memory 312b may be selected at random. Notably, only a subset of the second shard is copied to avoid exceeding a shard size in the first memory 312a.

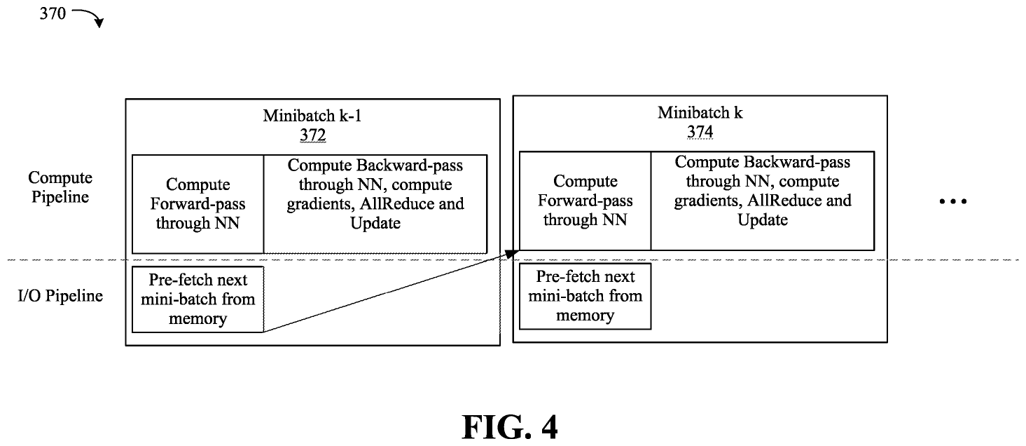

Turning now to FIG. 4, a processing diagram 370 is illustrated. The processing diagram 370 may generally be applicable to embodiments described herein, for example, the data-enhanced machine learning process 100 (FIG. 1), method 350 (FIG. 2) and/or process 300 (FIGS. 3A-3C) already discussed.

The compute pipeline may be executed by nodes and includes training a machine learning model. An I/O pipeline pre-fetches a next mini-batch from memory as the forward pass is executing in minibatch k−1 372. The mini-batch may be a data shard or a part of a data shard. The minibatch k 374 may then execute with no data waiting.

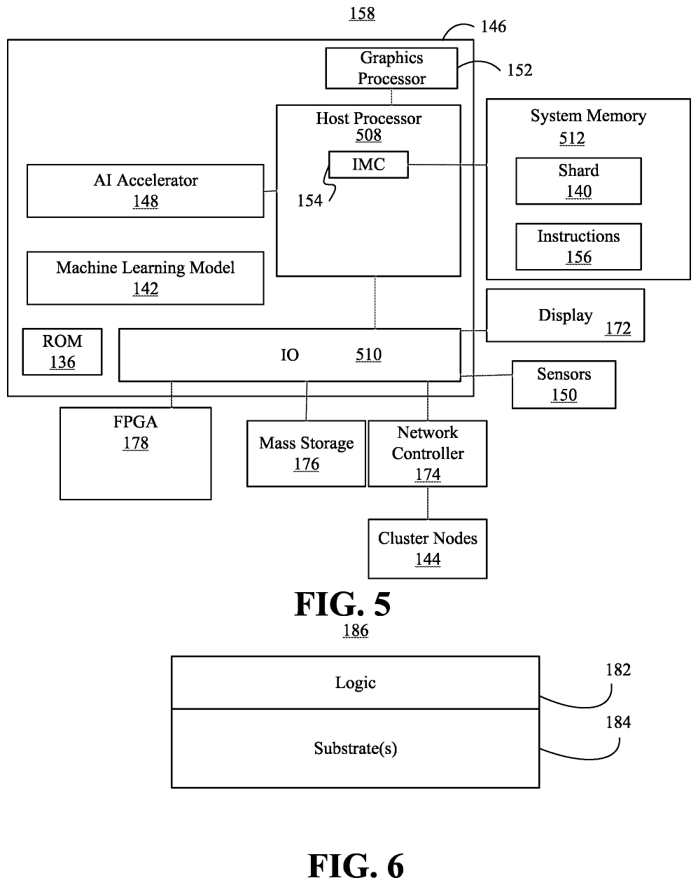

Turning now to FIG. 5, a training enhanced computing system 158 is shown. The training enhanced computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.) etc., or any combination thereof. In the illustrated example, the computing system 158 includes a host processor 508 (e.g., CPU) having an integrated memory controller (IMC) 154 that is coupled to a system memory 512.

The illustrated computing system 158 also includes an input output (TO) module 510 implemented together with the host processor 138, the graphics processor 152 (e.g., GPU), ROM 136, and AI accelerator 148 on a semiconductor die 146 as a system on chip (SoC). The illustrated IO module 510 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). The IO module 510 also communicates with sensors 150 (e.g., video sensors, audio sensors, proximity sensors, heat sensors, etc.). In some examples, the IO 510 may communicate with a data storage (e.g., a shared file system) via a network controller 174, where the data storage that stores training data. The IO 510 may also communicate with cluster nodes 144 to receive parts of shards of data. A shard 140 of the training data may be retrieved and stored in the system memory 512.

The SoC 146 may further include processors (not shown) and/or the AI accelerator 148 dedicated to artificial intelligence (AI) and/or neural network (NN) processing. For example, the system SoC 146 may include vision processing units (VPUs,) and/or other AI/NN-specific processors such as the AI accelerator 148, etc. In some embodiments, any aspect of the embodiments described herein may be implemented in the processors, such as the graphics processor 152 and/or the host processor 508, and in the accelerators dedicated to AI and/or NN processing such as AI accelerator 148 or other devices such as the FPGA 178. In this example, the shard 140 is copied into two different partitions of the system memory 512 to train a machine learning model 142 based on the copy of the shard 140 in one partition of the partitions, and loads data from other shards of cluster nodes 144 into the second partition to be mixed with the first shard.

The graphics processor 152, AI accelerator 148 and/or the host processor 508 may execute instructions 156 retrieved from the system memory 512 (e.g., a dynamic random-access memory) and/or the mass storage 176 to implement aspects as described herein. In some examples, when the instructions 156 are executed, the computing system 158 may implement one or more aspects of the embodiments described herein. For example, the computing system 158 may implement one or more aspects of the embodiments described herein, for example, the data-enhanced machine learning process 100 (FIG. 1), method 350 (FIG. 2), process 300 (FIGS. 3A-3C) and/or processing diagram 370 (FIG. 4) already discussed. The illustrated computing system 158 is therefore considered to be memory and performance-enhanced at least to the extent that the computing system 158 may execute machine learning operations with reduced latency.

FIG. 6 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein. For example, the apparatus 186 may generally implement the embodiments described herein, for example the data-enhanced machine learning process 100 (FIG. 1), method 350 (FIG. 2), process 300 (FIGS. 3A-3C) and/or processing diagram 370 (FIG. 4), already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

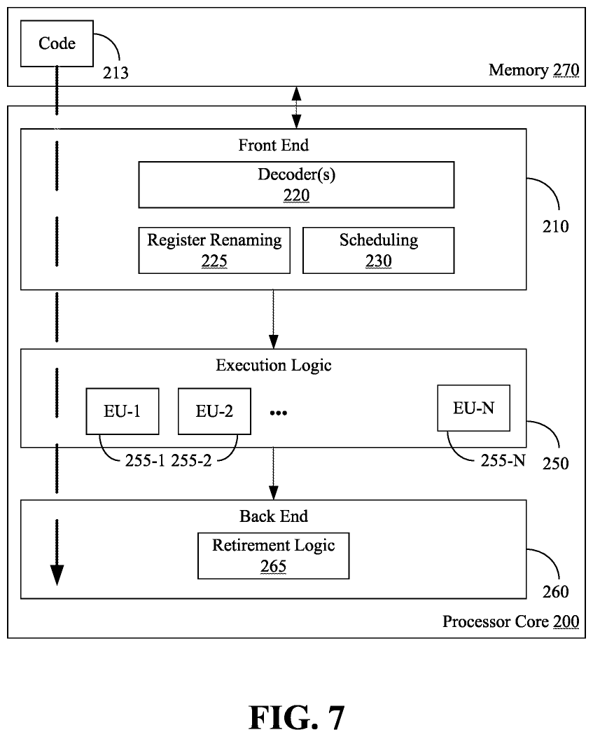

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the data-enhanced machine learning process 100 (FIG. 1), method 350 (FIG. 2), process 300 (FIGS. 3A-3C) and/or processing diagram 370 (FIG. 4) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

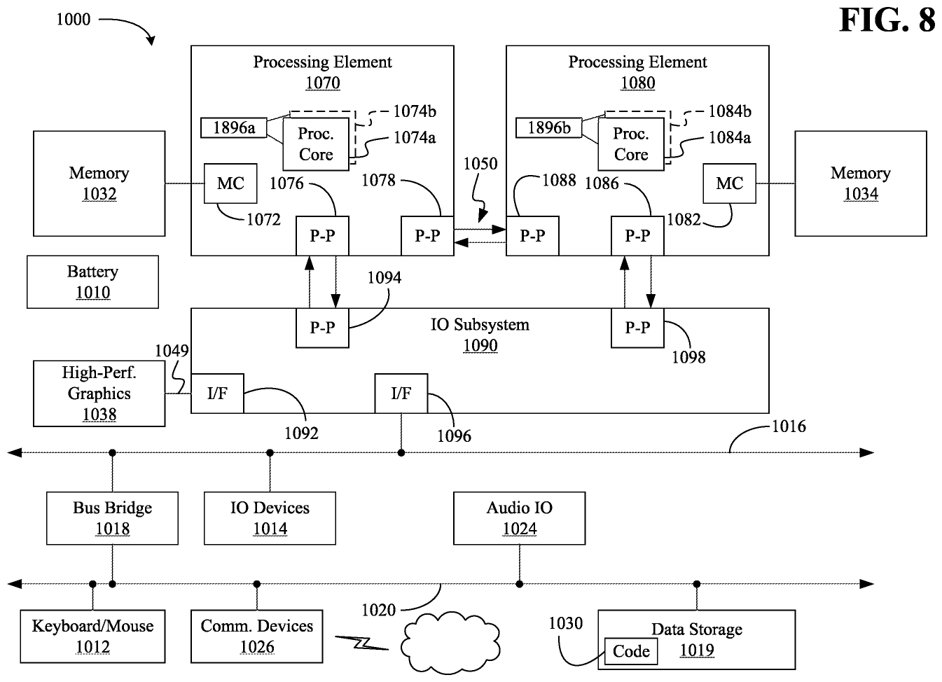

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the data-enhanced machine learning process 100 (FIG. 1), method 350 (FIG. 2), process 300 (FIGS. 3A-3C) and/or processing diagram 370 (FIG. 4) already discussed. Further, an audio I/O 1024 may be coupled to second bus 1020 and a battery 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### ADDITIONAL NOTES AND EXAMPLES

Example 1 includes a first compute node comprising a network controller to communicate with second compute nodes and a storage array, where the storage array is to store training data that is divided into shards, one or more of a processor implemented in one or more of configurable logic or fixed-functionality logic, or an accelerator implemented in one or more of configurable logic or fixed-functionality logic, a first data storage, a second data storage, and a memory including a set of instructions, which when executed by the one or more of the processor or the accelerator, cause the first compute node to store a first shard of the shards onto the first data storage, copy the first shard from the first data storage onto the second data storage, and train a machine learning model on the first shard stored in the first data storage during a first epoch of a training phase.

Example 2 includes the first compute node of claim 1, where the set of instructions, which when executed by the one or more of the processor or the accelerator, cause the first compute node to receive, during the first epoch, a second portion of a second shard of the shards from at least one of the second compute nodes, and store the second portion into the second data storage.

Example 3 includes the first compute node of claim 2, where the set of instructions, which when executed by the one or more of the processor or the accelerator, cause the first compute node to transfer the second portion of the second shard from the second data storage to the first data storage.

Example 4 includes the first compute node of claim 3, where to transfer the second portion of the second shard from the second data storage to the first data storage, the set of instructions, which when executed by the one or more of the processor or the accelerator, cause the first compute node to overwrite a first portion of the first shard stored in the first data storage with the second portion to generate a third shard.

Example 5 includes the first compute node of claim 4, where the set of instructions, which when executed by the one or more of the processor or the accelerator, cause the first compute node to shuffle data of the second portion and data of the first shard.

Example 6 includes the first compute node of claim 4, where the set of instructions, which when executed by the one or more of the processor or the accelerator, cause the first compute node to train the machine learning model based on the third shard stored in the first data storage during a second epoch of the training phase.

Example 7 includes the first compute node of any one of claims 3 to 6, where to transfer the second portion of the second shard from the second data storage to the first data storage, the set of instructions, which when executed by the one or more of the processor or the accelerator, cause the first compute node to transfer the second portion from the second data storage to the first data storage at memory speed, and where the first data storage is a first memory based local data storage, and where the second data storage is a second memory based local data storage.

Example 8 includes a semiconductor apparatus, the semiconductor apparatus comprising one or more substrates, and logic coupled to the one or more substrates, where the logic is implemented in one or more of configurable logic or fixed-functionality logic, the logic coupled to the one or more substrates to identify a first shard of shards of training data, where the training data is stored on a storage array, where the training data is divided into shards, store the first shard onto a first data storage of a first compute node, copy the first shard from the first data storage of the first compute node onto a second data storage of the first compute node, and train a machine learning model on the first shard stored in the first data storage during a first epoch of a training phase.

Example 9 includes the apparatus of claim 8, where the logic coupled to the one or more substrates is to receive, during the first epoch, a second portion of a second shard of the shards from a second compute node, and store the second portion into the second data storage.

Example 10 includes the apparatus of claim 9, where the logic coupled to the one or more substrates is to transfer the second portion of the second shard from the second data storage to the first data storage.

Example 11 includes the apparatus of claim 10, where to transfer the second portion of the second shard from the second data storage to the first data storage, the logic coupled to the one or more substrates is to overwrite a first portion of the first shard stored in the first data storage with the second portion to generate a third shard.

Example 12 includes the apparatus of claim 11, where the logic coupled to the one or more substrates is to shuffle data of the second portion and data of the first shard.

Example 13 includes the apparatus of claim 11, where the logic coupled to the one or more substrates is to train the machine learning model based on the third shard stored in the first data storage during a second epoch of the training phase.

Example 14 includes the apparatus of any one of claims 10 to 13, where to transfer the second portion of the second shard from the second data storage to the first data storage, the logic coupled to the one or more substrates is to transfer the second portion from the second data storage to the first data storage at memory speed, where the first data storage is a first memory based local data storage, and where the second data storage is a second memory based local data storage.

Example 15 includes the apparatus of claim 8, where the logic coupled to the one or more substrates includes transistor channel regions that are positioned within the one or more substrates.

Example 16 includes a method comprising identifying a first shard of shards of training data, where the training data is stored on a storage array, where the training data is divided into shards, storing the first shard onto a first data storage of a first compute node, copying the first shard from the first data storage of the first compute node onto a second data storage of the first compute node, and training a machine learning model on the first shard stored in the first data storage during a first epoch of a training phase.

Example 17 includes the method of claim 16, further comprising receiving, during the first epoch, a second portion of a second shard of the shards from a second compute node, and storing the second portion into the second data storage.

Example 18 includes the method of claim 17, further comprising transferring the second portion of the second shard from the second data storage to the first data storage.

Example 19 includes the method of claim 18, where the transferring further comprises overwriting a first portion of the first shard stored in the first data storage with the second portion to generate a third shard.

Example 20 includes the method of claim 19, further comprising shuffling data of the second portion and data of the first shard, and training the machine learning model based on the third shard stored in the first data storage during a second epoch of the training phase, where the transferring comprises transferring the second portion from the second data storage to the first data storage at memory speed, where the first data storage is a first memory based local data storage, and where the second data storage is a second memory based local data storage.

Example 21 includes an apparatus comprising means for identifying a first shard of shards of training data, where the training data is stored on a storage array, where the training data is divided into shards, means for storing the first shard onto a first data storage of a first compute node, means for copying the first shard from the first data storage of the first compute node onto a second data storage of the first compute node, and means for training a machine learning model on the first shard stored in the first data storage during a first epoch of a training phase.

Example 22 includes the apparatus of claim 21, further comprising means for receiving, during the first epoch, a second portion of a second shard of the shards from a second compute node, and means for storing the second portion into the second data storage.

Example 23 includes the apparatus of claim 22, further comprising means for transferring the second portion of the second shard from the second data storage to the first data storage.

Example 24 includes the apparatus of claim 23, where the transferring further comprises means for overwriting a first portion of the first shard stored in the first data storage with the second portion to generate a third shard.

Example 25 includes the apparatus of claim 24, further comprising means for shuffling data of the second portion and data of the first shard, and means for training the machine learning model based on the third shard stored in the first data storage during a second epoch of the training phase, where the transferring comprises transferring the second portion from the second data storage to the first data storage at memory speed, where the first data storage is a first memory based local data storage, and where the second data storage is a second memory based local data storage.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated. As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A first compute node comprising:
a network controller to communicate with second compute nodes and a storage array, wherein the storage array is to store training data that is divided into shards;
one or more of a processor implemented in one or more of configurable logic or fixed-functionality logic, or an accelerator implemented in one or more of configurable logic or fixed-functionality logic;
a first data storage;
a second data storage; and
a memory including a set of instructions, which when executed by the one or more of the processor or the accelerator, cause the first compute node to:
store a first shard of the shards onto the first data storage;
copy the first shard from the first data storage onto the second data storage; and
train a machine learning model on the first shard stored in the first data storage during a first epoch of a training phase.

2. The first compute node of claim 1, wherein the set of instructions, which when executed by the one or more of the processor or the accelerator, cause the first compute node to:
receive, during the first epoch, a second portion of a second shard of the shards from at least one of the second compute nodes; and
store the second portion into the second data storage.

3. The first compute node of claim 2, wherein the set of instructions, which when executed by the one or more of the processor or the accelerator, cause the first compute node to:
transfer the second portion of the second shard from the second data storage to the first data storage.

4. The first compute node of claim 3, wherein to transfer the second portion of the second shard from the second data storage to the first data storage, the set of instructions, which when executed by the one or more of the processor or the accelerator, cause the first compute node to:
overwrite a first portion of the first shard stored in the first data storage with the second portion to generate a third shard.

5. The first compute node of claim 4, wherein the set of instructions, which when executed by the one or more of the processor or the accelerator, cause the first compute node to:
shuffle data of the second portion and data of the first shard.

6. The first compute node of claim 4, wherein the set of instructions, which when executed by the one or more of the processor or the accelerator, cause the first compute node to:
train the machine learning model based on the third shard stored in the first data storage during a second epoch of the training phase.

7. The first compute node of claim 3, wherein to transfer the second portion of the second shard from the second data storage to the first data storage, the set of instructions, which when executed by the one or more of the processor or the accelerator, cause the first compute node to:
transfer the second portion from the second data storage to the first data storage at memory speed, and
wherein the first data storage is a first memory based local data storage, and
wherein the second data storage is a second memory based local data storage.

8. A semiconductor apparatus, the semiconductor apparatus comprising:
one or more substrates; and
logic coupled to the one or more substrates, wherein the logic is implemented in one or more of configurable logic or fixed-functionality logic, the logic coupled to the one or more substrates to:
identify a first shard of shards of training data, wherein the training data is stored on a storage array, wherein the training data is divided into shards;
store the first shard onto a first data storage of a first compute node;
copy the first shard from the first data storage of the first compute node onto a second data storage of the first compute node; and
train a machine learning model on the first shard stored in the first data storage during a first epoch of a training phase.

9. The apparatus of claim 8, wherein the logic coupled to the one or more substrates is to:
receive, during the first epoch, a second portion of a second shard of the shards from a second compute node; and
store the second portion into the second data storage.

10. The apparatus of claim 9, wherein the logic coupled to the one or more substrates is to:
transfer the second portion of the second shard from the second data storage to the first data storage.

11. The apparatus of claim 10, wherein to transfer the second portion of the second shard from the second data storage to the first data storage, the logic coupled to the one or more substrates is to:
overwrite a first portion of the first shard stored in the first data storage with the second portion to generate a third shard.

12. The apparatus of claim 11, wherein the logic coupled to the one or more substrates is to:
shuffle data of the second portion and data of the first shard.

13. The apparatus of claim 11, wherein the logic coupled to the one or more substrates is to:
train the machine learning model based on the third shard stored in the first data storage during a second epoch of the training phase.

14. The apparatus of claim 10, wherein to transfer the second portion of the second shard from the second data storage to the first data storage, the logic coupled to the one or more substrates is to:
transfer the second portion from the second data storage to the first data storage at memory speed,
wherein the first data storage is a first memory based local data storage, and
wherein the second data storage is a second memory based local data storage.

15. The apparatus of claim 8, wherein the logic coupled to the one or more substrates includes transistor channel regions that are positioned within the one or more substrates.

16. A method comprising:
identifying a first shard of shards of training data, wherein the training data is stored on a storage array, wherein the training data is divided into shards;
storing the first shard onto a first data storage of a first compute node;
copying the first shard from the first data storage of the first compute node onto a second data storage of the first compute node; and
training a machine learning model on the first shard stored in the first data storage during a first epoch of a training phase.

17. The method of claim 16, further comprising:
receiving, during the first epoch, a second portion of a second shard of the shards from a second compute node; and
storing the second portion into the second data storage.

18. The method of claim 17, further comprising:
transferring the second portion of the second shard from the second data storage to the first data storage.

19. The method of claim 18, wherein the transferring further comprises:
overwriting a first portion of the first shard stored in the first data storage with the second portion to generate a third shard.

20. The method of claim 19, further comprising:
shuffling data of the second portion and data of the first shard; and
training the machine learning model based on the third shard stored in the first data storage during a second epoch of the training phase,
wherein the transferring comprises transferring the second portion from the second data storage to the first data storage at memory speed,
wherein the first data storage is a first memory based local data storage, and
wherein the second data storage is a second memory based local data storage.
